(19) United States
(12) Patent Application Publication
(10) Pub. No.: US 2013/0066791 A1
(43) Pub. Date: Mar. 14, 2013

(54) DEVICE AND METHOD FOR DETERMINING STORAGE BATTERY RENTAL CAPACITY

(71) Applicants: Hideo SAKAMOTO, Kawasaki-shi (JP); Kazuto KUBOTA, Kawasaki-shi (JP); Shuichiro IMAHARA, Kawasaki-shi (JP)

(72) Inventors: Hideo SAKAMOTO, Kawasaki-shi (JP); Kazuto KUBOTA, Kawasaki-shi (JP); Shuichiro IMAHARA, Kawasaki-shi (JP)

(73) Assignee: Kabushiki Kaisha Toshiba, Tokyo (JP)

(21) Appl. No.: 13/543,077

(22) Filed: Jul. 6, 2012

(30) Foreign Application Priority Data
Sep. 9, 2011 (JP) 2011-197529

(51) Int. Cl. G06Q 30/00

(52) U.S. Cl. 705/307

(57) ABSTRACT

There is provided a device for determining a rental capacity of a storage battery in which an appliance load predicting unit predicts a demand amount of a household electrical appliance; a power generator predicting unit predicts a power generation amount of a power generator; a constraint condition creating unit creates a constraint condition including first and second constraint expressions, the former matching the predicted demand amount with total electric power supplied to the household electrical appliance and the latter matching the predicted power generation amount with a sum of a power sale amount to the power supplier, a charge amount into the storage battery, and a supply amount to the household electrical appliance; an objective function creating unit creates an objective function based on a sale benefit function, a rental benefit function, a purchase cost function; and an optimization computing unit optimize the objective function to obtains a rental capacity.

### CROSS REFERENCE TO RELATED APPLICATIONS

This application is based upon and claims the benefit of priority from the prior Japanese Patent Application No. 2011-197529, filed on Sep. 9, 2011, the entire contents of which are incorporated herein by reference.

### FIELD

The present embodiments described herein relates to a device and a method for determining a storage battery rental capacity, for example, relates, in a smart grid, to a device and a method for determining a storage battery capacity, which a consumer rents to a power supplier who supplies electric power to the consumer in order to share a storage battery owned by the consumer with the power supplier.

### BACKGROUND

As a conventional technique, a consumer having a power generator, a storage battery, and a household electrical appliance determines a ratio of an amount of electric power to be sold out of a power generation amount, a charge and discharge amount into and from a storage battery, and a power supply source (the power generator, the storage battery, a system or the like) and a power supply amount to the household electrical appliance to thereby obtain a maximum power trading benefit.

In the conventional technique, the storage battery owned by the consumer is used only by the consumer. A capacity of the storage battery is temporarily rented to a power supplier. Accordingly, the benefit may be increased, and power usage efficiency may be improved.

In this case, when the power supplier proposes to use a part or all of the capacity of the storage battery to the consumer having the storage battery, the consumer has no means to predict an influence obtained by renting the capacity. That is, when the capacity is rented, stored electric power cannot be supplied to the household electrical appliance, so that a power purchase cost may not be reduced. Since surplus electric power which is supposed to be sold to the system is reduced so as to satisfy a demand of the household electrical appliance, a power sale benefit may be also decreased. It is thus difficult for the consumer to determine whether or not the capacity of the storage battery can be actually rented.

Even when the capacity is rented, the consumer also does not have any means to determine how much capacity can be rented. If the rental capacity is too much, the power purchase cost may be increased, or the power sale benefit may be decreased. On the contrary, if the rental capacity is too small, a benefit which is supposed to be obtained by renting the capacity may not be obtained.

### BRIEF DESCRIPTION OF THE DRAWINGS

FIG. 1 is a block diagram showing a system configuration example according to a present embodiment;

FIG. 2 is a diagram showing a configuration example of a storage battery rental capacity determining unit;

FIG. 3 is a flowchart showing one operation example of the storage battery rental capacity determining unit;

FIG. 4 is a view for explaining a network and symbols;

FIG. 5 is a flowchart showing one operation example of a constraint condition creating unit;

FIG. 6 is a flowchart showing a detailed operation for creating a storage battery capacity constraint;

FIG. 7 is a flowchart showing one operation example of an objective function creating unit;

FIG. 8 is a graph showing one example of a storage battery rental price function;

FIG. 9 is a graph showing one example of a power trading price;

FIG. 10 is a graph showing one example of a predicted power generation amount;

FIG. 11 is a graph showing one example of a predicted household electrical appliance load amount;

FIG. 12 is a graph showing a result example of a power storage amount of a storage battery;

FIG. 13 is a graph showing a result example of a charge and discharge amount of the storage battery;

FIG. 14 is a graph showing a result example of a power trading amount with a power system;

FIG. 15 is a graph showing a result example of a supply source of a household electrical appliance load;

FIG. 16 is a graph showing a result example of a supply destination of a power generator;

FIG. 17 is a flowchart showing one operation example of a constraint condition creating unit according to a second embodiment;

FIG. 18 is a flowchart showing one example of an operation for creating a storage battery capacity constraint according to the second embodiment;

FIG. 19 is a graph showing a result example of a power storage amount of a storage battery according to the second embodiment;

FIG. 20 is a graph showing a result example of a charge and discharge amount of the storage battery according to the second embodiment;

FIG. 21 is a graph showing a result example of a power trading amount with a power system according to the second embodiment;

FIG. 22 is a graph showing a result example of a supply source of a household electrical appliance load according to the second embodiment; and

FIG. 23 is a graph showing a result example of a supply destination of a power generator according to the second embodiment.

### DETAILED DESCRIPTION

According to an embodiment, there is provided a device that determines a rental capacity of a storage battery to rent to a power supplier a part or all of a capacity of the storage battery owned by a consumer who has a power generator, the storage battery, and a household electrical appliance, and purchases electric power from the power supplier.

The device includes a condition acquiring unit, an appliance load predicting unit, a power generator predicting unit, a constraint condition creating unit, an objective function creating unit, and an optimization computing unit.

The condition acquiring unit acquires a rental condition of the storage battery, the rental condition including a rental period to the power supplier, and a rental price of each of rental capacities.

The appliance load predicting unit predicts a demand amount of the household electrical appliance with respect to a time zone including the rental period based on an operation history of the household electrical appliance.

The power generator predicting unit predicts a power generation amount of the power generator with respect to the time zone including the rental period based on an power generation history of the power generator.

The constraint condition creating unit creates a constraint condition including a first constraint expression and a second satisfaction constraint expression with respect to the time zone including the rental period.

The first constraint expression is configured to match the demand amount of the household electrical appliance with total electric power supplied to the household electrical appliance from the power generator, the storage battery, and the power supplier.

The second constraint expression is configured to match the power generation amount of the power generator with a sum of a power sale amount to the power supplier, a charge amount into the storage battery, and a supply amount to the household electrical appliance.

The objective function creating unit creates a first objective function or a second objective function by using sale price data and purchase price data of electric power, a purchase cost function in the rental period, a sale benefit function in the rental period, and a rental benefit function of the rental capacity.

The first objective function defines to subtract the sale benefit function and the rental benefit function from the purchase cost function.

The second objective function defines to subtract the purchase cost function from a sum of the sale benefit function and the rental benefit function.

The optimization computing unit minimizes the first objective function or maximizes the second objective function under the constraint condition to obtain a rental capacity rentable to the power supplier in the rental period.

Hereinafter, embodiments will be described with reference to the accompanying drawings.

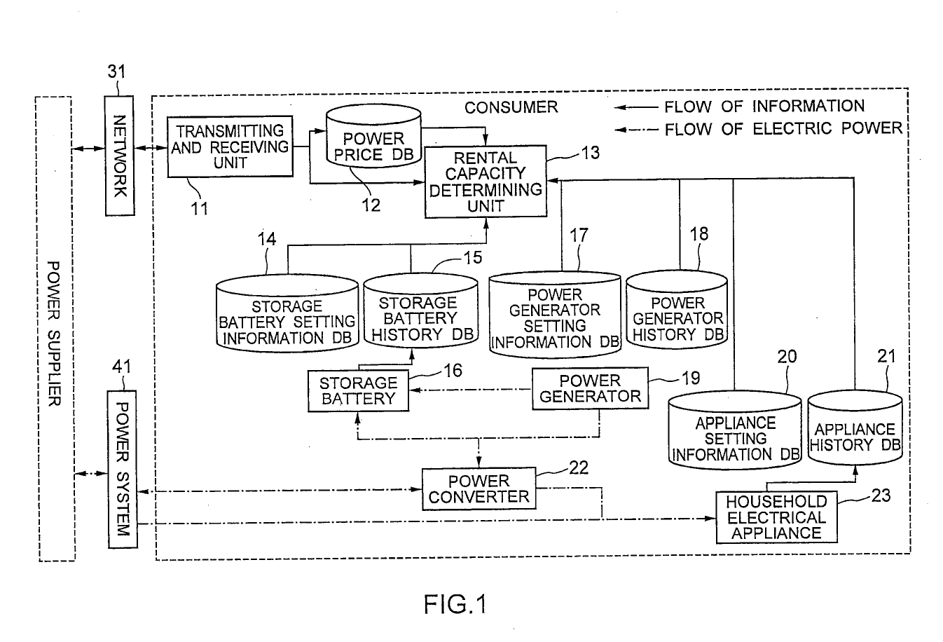

FIG. 1 is a diagram showing a schematic configuration of a storage battery renting system including a storage battery rental capacity determining device according to one embodiment (a first embodiment).

The storage battery renting system is composed of a consumer, a power supplier (e.g., an electric power company) who supplies alternating-current power to the consumer or purchases alternating-current power from the consumer, a power system 41 that transmits alternating-current power, and a network 31 that transmits and receives information.

The consumer has a power generator 19 that generates direct-current power, a storage battery 16 that can store direct-current power and can be charged and discharged at the same time, a household electrical appliance 23 that consumes alternating-current power, and a power converter 22 that converts an alternating current to a direct current, or a direct current to an alternating current.

In the power generator 19 owned by the consumer, a power generator history DB (database) 18 that records a power generation history, and a power generator setting information DB 17 that records specification information of the power generator 19, a setting value set by the consumer, or the like are arranged corresponding to each other.

In the storage battery 16 owned by the consumer, a storage battery history DB 15 that records a charge and discharge history, and a storage battery setting information DB 14 that records specification information of the storage battery 16, a setting value set by the consumer, or the like are arranged corresponding to each other.

In the household electrical appliance 23 owned by the consumer, a household electrical appliance history DB 21 that records an operation history of the household electrical appliance, and a household electrical appliance setting information DB 20 that records specification information of the household electrical appliance 23, a setting value set by the consumer, or the like are arranged corresponding to each other.

A transmitting and receiving unit 11 transmits and receives information via the network 31 between the power supplier and the consumer.

A power price DB 12 stores power trading information (sale price data and purchase price data of electric power) appropriately proposed to the consumer from the power supplier. The power price DB 12 also stores storage battery rental conditions (described later) proposed to the consumer from the power supplier.

A storage battery rental capacity determining unit (the storage battery rental capacity determining device) 13 calculates a storage battery rentable capacity to the power supplier from the consumer, and determines whether to rent a desired rental capacity requested by the power supplier.

Electric power is supplied to the consumer from the power supplier via the power system 41. When electric power from the power system 41 is charged into the storage battery 16, the electric power, which is alternating-current power, is converted to direct-current power by the power converter 22, and charged into the storage battery 16. When electric power is discharged to the household electrical appliance 23 or the system 41 from the storage battery 16, the electric power is converted from direct-current power to alternating-current power by the power converter 22, and discharged to the household electrical appliance 23 or the system 41. Similarly, when electric power is transmitted to the household electrical appliance 23 or the system 41 from the power generator 19, the electric power is converted from direct-current power to alternating-current power by the power converter 22, and transmitted to the household electrical appliance 23 or the system 41.

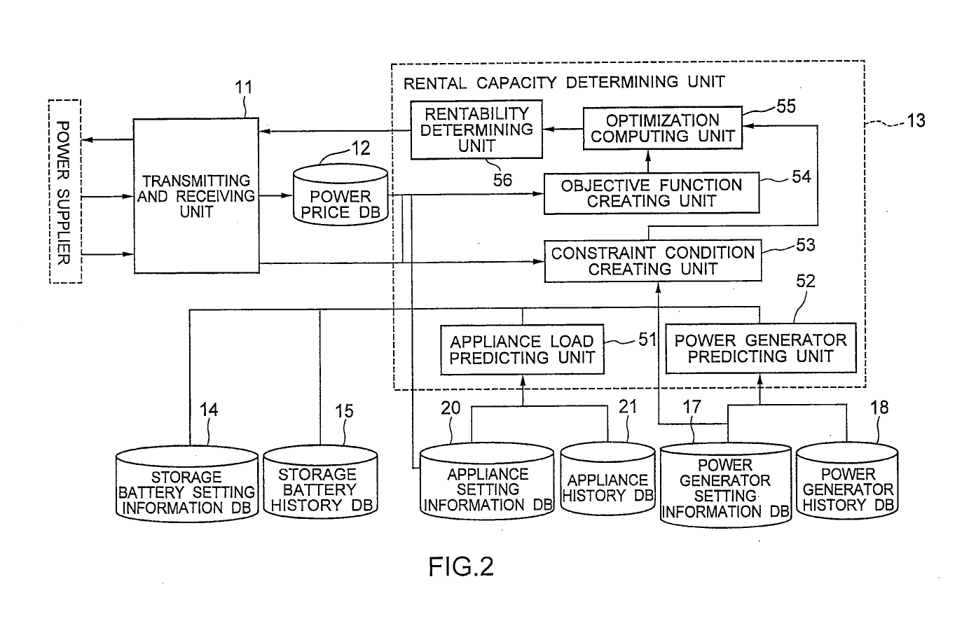

FIG. 2 is a block diagram showing a configuration example of the storage battery rental capacity determining unit 13. The storage battery rental capacity determining unit 13 is composed of an appliance load predicting unit 51, a power generator predicting unit 52, a constraint condition creating unit 53, an objective function creating unit 54, an optimization computing unit 55, and a rentability determining unit 56. The constraint condition creating unit 53 and the objective function creating unit 54 include a condition acquiring unit that acquires the storage battery rental conditions via the transmitting and receiving unit 11.

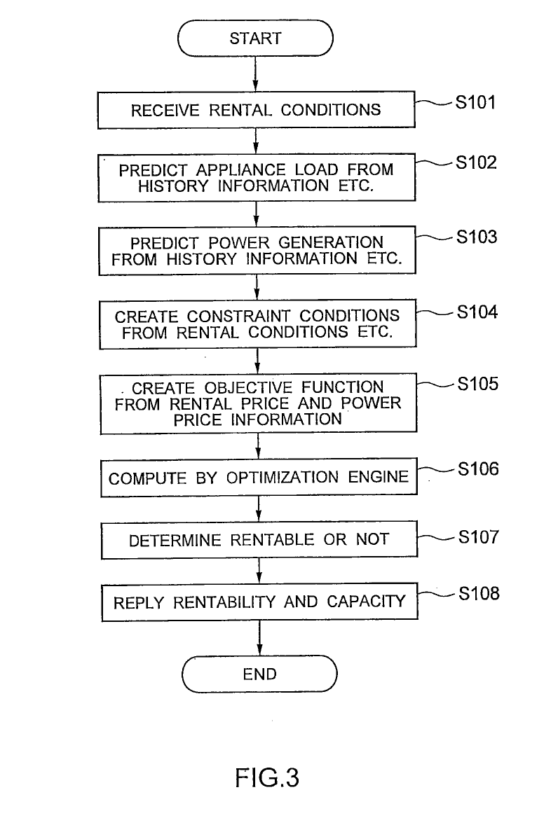

FIG. 3 is a flowchart of the storage battery rental capacity determining unit 13.

First, in a first step, the storage battery rental conditions proposed by the power supplier are received via the transmitting and receiving unit 11 (S101). The storage battery rental conditions include a rental start time, a rental period length, a rental price, and a desired rental capacity. If the desired rental capacity is not specified, the desired rental capacity is considered to be 0. A period having the rental period length from the rental start time is referred to as rental period. The rental period may be also identified by specifying the rental start time and a rental end time. In the present embodiment, the rental start time and the rental period length are considered to be within 24 hours from the reception of the rental conditions. The received storage battery rental conditions are stored in the power price DB 12.

In a second step, the appliance load predicting unit 51 predicts a household electrical appliance load amount as a power consumption amount of the household electrical appliance 23 during a period “T” from a present time by using the household electrical appliance history information registered in the household electrical appliance history DB 21, the household electrical appliance setting information registered in the household electrical appliance setting information DB 20, calendar information, and a weather forecast (S102). In the present embodiment, “T” is 24 hours (1440 minutes), and a time unit is considered to be 30 minutes. Although the present time may be determined in any manner, the present time is set to a time at which the storage battery rental conditions are received in S101 here. The same applies to a description below. Since a method of predicting the power consumption amount (the household electrical appliance load amount) is not the essence of the present embodiment, any method may be used. For example, future power consumption may be estimated from future predicted weather and temperature (acquired from an external server) based on past power consumption, temperature and weather. For the estimation, a regression analysis may be used, or a neural network may be used. The future power consumption may be also predicted only from a past power consumption history without using weather and temperature.

In a third step, the power generator predicting unit 52 calculates a power generation amount of the power generator 19 during the period “T” from on the present time by using the power generator history information registered in the power generator history DB 18, the power generator setting information registered in the power generator setting information DB 17, the calendar information, and the weather forecast (S103). Since the prediction of the power generation amount is also not the essence of the present embodiment similarly to the prediction of the power consumption, any method may be used. For example, future power generation may be estimated from future predicted weather and temperature (acquired from an external server) based on past power generation, temperature and weather. For the estimation, a regression analysis may be used, or a neural network may be used. The future power generation may be also predicted only from a past power generation history without using weather and temperature.

In a fourth step, the constraint condition creating unit 53 creates constraint conditions by a mixed integer programming problem by using the rental start time and the rental period length, the predicted household electrical appliance load amount calculated as above, the predicted power generation amount calculated as above, the power generator setting information registered in the power generator setting information DB 17, the storage battery history information registered in the storage battery history DB 15, and the storage battery setting information registered in the storage battery setting information DB 14 (S104). The step will be described in detail later.

In a fifth step, the objective function creating unit 54 creates an objective function by the mixed integer programming problem by using the household electrical appliance setting information registered in the household electrical appliance setting information DB 20, and the power trading price information and the rental price registered in the power price DB 12 (S105). The step will be described in detail later.

In a sixth step, the optimization computing unit 55 solves an optimization problem as the mixed integer programming problem by using the created constraint conditions and the created objective function (S106).

In a seventh step, the rentability determining unit 56 compares a rental capacity (a rentable capacity) included in the solved optimization solution and the desired rental capacity, and determines that the rental capacity is rentable when the rentable capacity is larger than the desired rental capacity, and that the rental capacity is not rentable when the rentable capacity is smaller than the desired rental capacity (S107).

In an eighth step, the transmitting and receiving unit 11 transmits the obtained rentability result and, if rentable, the rental capacity (corresponding to the desired rental capacity in this case) to the power supplier (S108).

As another operation example, when the rentable capacity is larger than the desired rental capacity, the transmitting and receiving unit 11 may transmit a response to the power supplier that a capacity equal to or less than the rentable capacity is rentable.

The power supplier can freely use (charge and discharge) the rented capacity during the rental period by accessing the storage battery of the consumer via the power system.

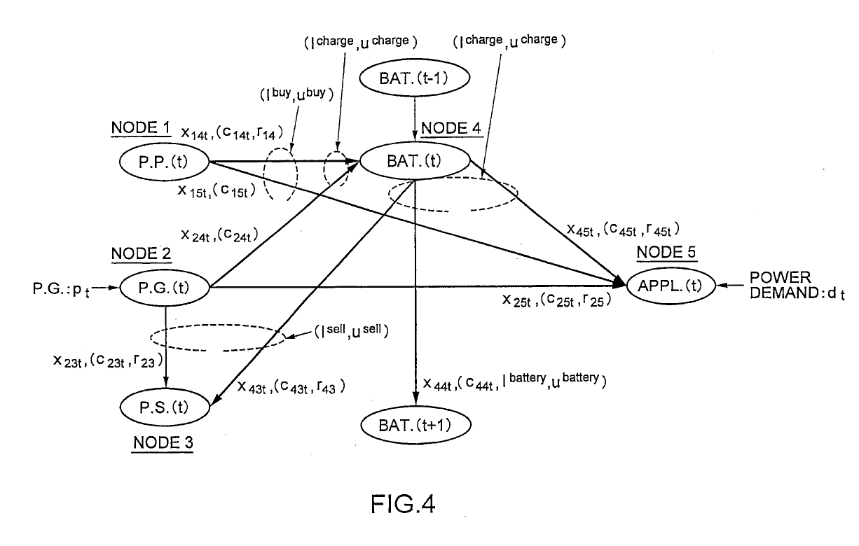

FIG. 4 is a view in which symbols used in a following description are assigned to a network flow showing a flow of electric power among the elements shown in FIG. 1. In the following, the symbols will be described.

In FIG. 4, the “power system” is divided into a “power purchase (P.P.)” node (or a node 1) and a “power sale (P.S.)” node (or a node 3). The “power generator” is considered as a “power generation (P.G.)” node (or a node 2). The “storage battery” is considered as a “storage battery (BAT.)” node (or a node 4). The “household electrical appliance” is considered as a “household electrical appliance (APPL.)” node (or a node 5). The “power converter” in FIG. 1 is omitted.

“xᵢⱼₜ” is a variable that represents an amount of electric power flowing from a node “i” to a node “j” at a time “t” (xᵢⱼₜ≧0).

“cᵢⱼₜ” is a constant that represents a cost for supplying (transmitting) electric power from the node “i” to the node “j” at the time “t” (cᵢⱼₜ≦0).

“rᵢⱼ” is a constant that represents conversion efficiency (efficiency of conversion from a direct current to an alternating current or vice versa) for supplying electric power from the node “i” to the node “j” (1≦rᵢⱼ≦0).

“pₜ” is a constant that represents a predicted power generation amount generated by the power generator at the time “t” (pₜ≦0).

“dₜ” is a constant that represents a predicted power demand amount consumed by the household electrical appliance at the time “t” (dₜ≦0).

“I^{charge}” is constant that represents a lower limit power amount charged into or discharged from the storage battery (I^{charge}≦0).

“u^{charger}” is a constant that represents an upper limit power amount charged into or discharged from the storage battery (u^{charge}≦0).

“I^{battery}” is a constant that represents a lower limit power amount of a storage battery capacity (I^{battery}≦0).

“u^{battery}” is a constant that represents an upper limit power amount of the storage battery capacity (u^{battery}≦0).

“I^{buy}” is a constant that represents a lower limit power amount when electric power is purchased from the system (I^{buy}≦0).

“u^{buy}” is a constant that represents an upper limit power amount when electric power is purchased from the system (u^{buy}≦0).

“I^{sell}” is a constant that represents a lower limit power amount when electric power is sold to the system (I^{sell}≦0).

“u^{sell}” is a constant that represents an upper limit power amount when electric power is sold to the system (u^{sell}≦0).

Other symbols not shown in FIG. 4 will be also described.

“N={1,2,3,4,5}” is a set of the nodes described by using FIG. 4.

“{1, 2, 3, . . . , T−1,T}” is a set of times.

“Tᵣₑₙₜₐₗ” is a set of times included in the rental period.

“Tₙₒₜ_{_{—}}ᵣₑₙₜₐₗ” is a set of times not included in the rental period.

“Xᵣₑₙₜₐₗ_{_{—}}_{size}” is a variable that represents a rental capacity of the storage battery (xᵣₑₙₜₐₗ_{_{—}}_{size}≦0).

“zₜ^{buy}” is a variable that becomes 1 when electric power is purchased from the system at the time “t” (zₜ^{buy}ε{0,1}).

“zₜ^{sell}” is a variable that becomes 1 when electric power is sold to the system at the time “t” (zₜ^{sell}ε{0,1}).

“z_{yes}^{rental}” is a variable that becomes 1 when the storage battery is partially or entirely rented (z_{yes}^{rental}ε{0,1}).

“zₙₒ^{rental}” is a variable that becomes 1 when the storage battery is not rented (zₙₒ^{rental}ε{0,1}).

“b₀” is a constant that represents an initial capacity of the storage battery.

“b_{T}” is a constant that represents a capacity of the storage battery at the end.

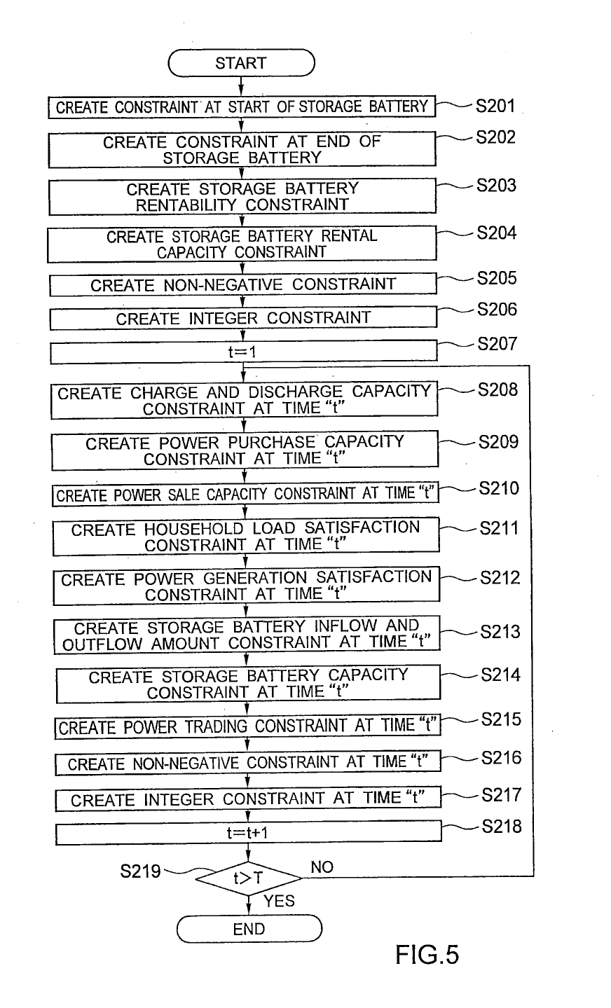

FIG. 5 is a flowchart showing one operation example of the constraint condition creating unit 53 in FIG. 3.

First, in a first step,

x₄₄₀=b₀

as a constraint at the start of the storage battery is added as a constraint expression (S201). The constraint expression is a constraint expression for setting the initial capacity of the storage battery. A numerical value registered in the storage battery history DB 15 is used as “b₀”.

In a second step,

x_{44T}≦b_{T+1}

as a constraint at the end of the storage battery is added as a constraint expression (S202). The constraint expression is a constraint expression for setting the capacity of the storage battery at the end. A numerical value registered in the storage battery setting information DB 14 is used as “b_{T}”.

As a third step,

z_{yes}^{rental}+zₙₒ^{rental}=1

as a storage battery rentability constraint is added as a constraint expression (S203). The constraint expression is added so as not to determine, at the same time, to rent the rental capacity and not to rent the rental capacity.

As a fourth step,

0≦xᵣₑₙₜₐₗ_{_{—}}_{size}≦(u^{battery}−l^{battery})z_{yes}^{rental}

as a storage battery rental capacity constraint is added as a constraint expression (S204). The constraint expression is added so as to set an upper limit of the rental capacity to a maximum capacity (a value obtained by subtracting the lower limit power amount of the storage battery capacity from the upper limit power amount thereof) of the storage battery when it is determined to rent the rental capacity, and so as to set the rental capacity to 0 when it is determined not to rent the rental capacity. Numerical values registered in the storage battery setting information DB 14 are used as the upper and lower limits of the storage battery capacity.

As to the upper limit power amount and the lower limit power amount of the storage battery capacity, it is generally said that lithium-ion storage batteries or the like are reduced in capacity when a full charge state is maintained, or batteries have a shorter operating life when the batteries are recharged after being fully discharged. Thus, a charge state is required to be maintained between 20% and 80% in view of suppressing deterioration in battery capacity, for example. For this reason, the maximum capacity based on the upper limit power amount and the lower limit power amount is determined as described above.

As a fifth step,

xᵣₑₙₜₐₗ_{_{—}}_{size}≧0

as a non-negative constraint is added as a constraint expression (S205).

As a sixth step,

z_{yes}^{rental}ε{0,1},zₙₒ^{rental}ε{0,1}

as an integer constraint is added as a constraint expression (S206).

As a seventh step, a following loop calculation is started by setting an internal variable “t” representing the time to 1 (S207).

As an eighth step,

l^{charge}≦x₁₄ₜ+x₂₄ₜ+x₄₃ₜ+x₄₅ₜ≦u^{charge∀}tε{1, 2, 3, . . . , T−1, T}

as a charge and discharge capacity constraint is added as a constraint expression (S208). The constraint expression is added so as to set upper and lower limit rates of charge and discharge into and from the storage battery at the time “t”. Numerical values registered in the storage battery setting information DB 14 are used as the upper and lower limits of the storage battery charge and discharge rate.

As a ninth step,

l^{buy}≦x₁₄ₜ+x₁₅ₜ≦u^{buy}zₜ^{buy∀}tε{1, 2, 3, . . . , T−1, T}

as a power purchase capacity constraint is added as a constraint expression (S209). The constraint expression is added so as to set upper and lower limit rates for purchasing electric power from the system 41 at the time “t”. Numerical values registered in the household electrical appliance setting information DB 20 are used as the upper and lower limit rates for purchasing electric power. When it is determined not to purchase electric power from the system 41 at the time “t”, the right-hand side is set to 0.

As a tenth step,

l^{sell}≦r₂₃x₂₃ₜ+r₄₃x₄₃ₜ≦u^{sell}zₜ^{sell∀}tε{1, 2, 3, . . . , T−1, T}

as a power sale capacity constraint is added as a constraint expression (S210). The constraint expression is added so as to set upper and lower limit rates for selling electric power to the system 41 at the time “t”. Numerical values registered in the household electrical appliance setting information DB 20 are used as the upper and lower limit rates for selling electric power. When it is determined not to sell electric power to the system 41 at the time “t”, the right-hand side is set to 0. Since the conversion between a direct current and an alternating current is included, conversion efficiency “r” is multiplied.

As an eleventh step,

x₁₅ₜr₂₅x₂₅ₜ+r₄₅x₄₅ₜ=dₜ^{∀}tε{1, 2, 3, . . . , T−1, T}

as a household load satisfaction constraint is added as a constraint expression (S211). The constraint expression is added so as to match the power demand amount of the household electrical appliance 23 with a sum of a purchase amount from the system 41, a supply amount from the power generator 19, and a discharge amount from the storage battery 16 at the time “t”. Numerical values registered in the household electrical appliance setting information DB 20 are used as conversion efficiency for transmitting electric power from the power generator 19 to the household electrical appliance, and conversion efficiency for transmitting electric power from the storage battery 16 to the household electrical appliance.

As a twelfth step,

x₂₃ₜ+x₂₄ₜ+x₂₅ₜ=pₜ^{∀}tε{1, 2, 3, . . . , T−1, T}

as a power generation satisfaction constraint is added as a constraint expression (S212). The constraint expression is added so as to match the power generation amount of the power generator 19 with a sum of a sale amount to the system 41, a charge amount into the storage battery 16, and a supply amount to the household electrical appliance 23 at the time “t”.

As a thirteenth step,

x₄₄ₜ₋₁+r₁₄x₁₄ₜ+x₂₄ₜ=x₄₃ₜ+x₄₄ₜ+x₄₅ₜ^{∀}tε{1, 2, 3, . . . , T−1, T}

as a storage battery inflow and outflow amount constraint is added as a constraint expression (S213). The constraint expression is added so as to match a sum of a carryover amount from a previous time, a purchase amount from the system 41, and a charge amount from the power generator 19 with a sum of a sale amount to the system 41, a carryover amount to a next time, and a supply amount to the household electrical appliance 23 at the time “t”. A numerical value registered in the household electrical appliance setting information DB 20 is used as conversion efficiency for transmitting electric power from the system 41 to the storage battery 16.

As a fourteenth step, a storage battery capacity constraint is added as a constraint expression (S214). The step will be described in detail later.

As a fifteenth step,

zₜ^{buy}+zₜ^{sell}=1^{∀}tε{1, 2, 3, . . . , T−1, T}

as a power trading constraint is added as a constraint expression (S215). The constraint expression is added so as not to determine, at the same time, to purchase electric power from the system 41 and to sell electric power to the system 41 at the time “t”.

As a sixteenth step,

xᵢⱼₜ≧0^{∀}tε{1, 2, 3, . . . , T−1, T},^{∀}iεN,^{∀}jεN

as a non-negative constraint is added as a constraint expression (S216).

As a seventeenth step,

zₜ^{buy}ε{0,1},zₜ^{sell}ε^{∀}tε{1, 2, 3, . . . , T−1, T}

as an integer constraint is added as a constraint expression (S217).

As an eighteenth step, 1 is added to the internal variable “t” representing the time (S218).

As a nineteenth step, the internal variable “t” is compared with an end time “T” (S219). The process is terminated when the internal variable “t” is larger. The process returns to the eighth step when the internal variable “t” is smaller.

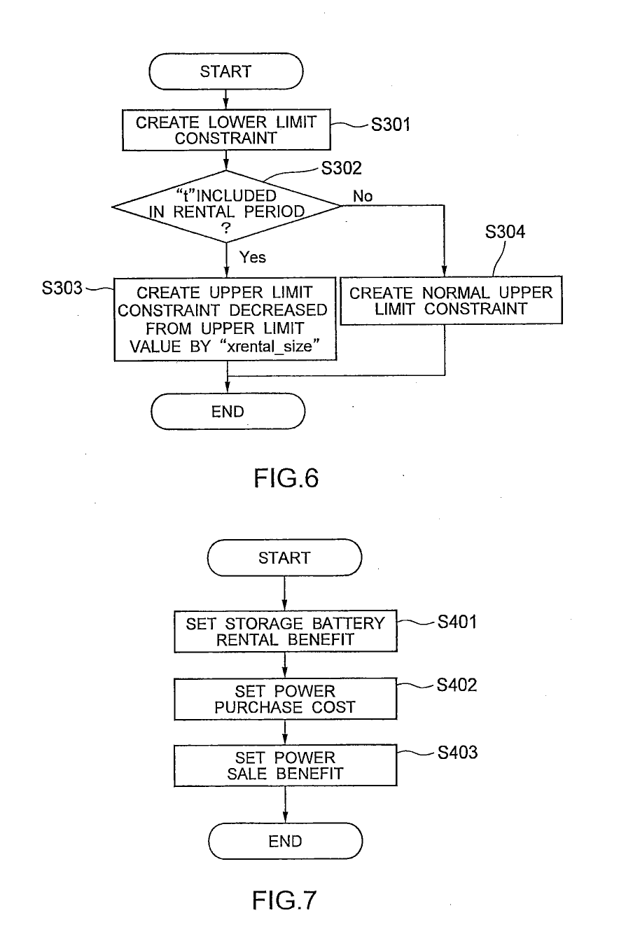

FIG. 6 is a flowchart showing a detailed example of the storage battery capacity constraint (S214) in FIG. 5.

As a first step,

l^{battery}≦x₄₄ₜ₋₁^{∀}tε{1, 2, 3, . . . , T−1, T}

as a lower limit constraint of the storage battery capacity is added as a constraint expression (S301). The constraint expression is added so as to set a lower limit of the storage battery capacity at the time “t”. A numerical value registered in the storage battery setting information DB 14 is used as the lower limit of the storage battery capacity.

As a second step, it is confirmed whether the internal variable “t” is included in the rental period proposed by the power supplier (S302). When the internal variable “t” is not included, the process proceeds to a third step. When the internal variable “t” is included, the process proceeds to a fourth step.

As the third step,

x₄₄ₜ₋₁≦u^{battery∀}tεTₙₒₜ_{_{—}}ᵣₑₙₜₐₗ

as an upper limit constraint of the storage battery capacity is added as a constraint expression (S303). The constraint expression is added so as to set an upper limit of the storage battery capacity at the time “t”. A numerical value registered in the storage battery setting information DB 14 is used as the upper limit of the storage battery capacity.

As the fourth step,

x₄₄ₜ₋₁≦u^{battery}−xᵣₑₙₜₐₗ_{_{—}}_{size}^{∀}tεTᵣₑₙₜₐₗ

as an upper limit constraint of the storage battery capacity is added as a constraint expression (S304). The constraint expression is added so as to set the upper limit of the storage battery capacity to not the normal upper limit, but an upper limit decreased by “Xᵣₑₙₜₐₗ_{_{—}}_{size}” since the time “t” is included in the rental period. A numerical value registered in the storage battery setting information DB 14 is used as the upper limit of the storage battery capacity. Due to the constraint, the rental capacity is rented in an empty state of the rental capacity when rented. A condition that the rental capacity is fully charged or charged at a given rate when rented may be also employed. In this case, a constraint corresponding to the condition may be added.

By setting as described above, electric power can be also stored in the storage battery during the rental period even though the amount of storage is smaller than the original upper limit amount. As a result, effective capacity management can be achieved for the storage battery.

FIG. 7 is a flowchart showing one operation example of the objective function creating unit 54 in FIG. 3.

In the following, a case in which the objective function is a cost function, i.e., an example in which the objective function is minimized will be described. However, even in a case in which the objective function is maximized, the same process may be executed as a benefit function by inverting the sign.

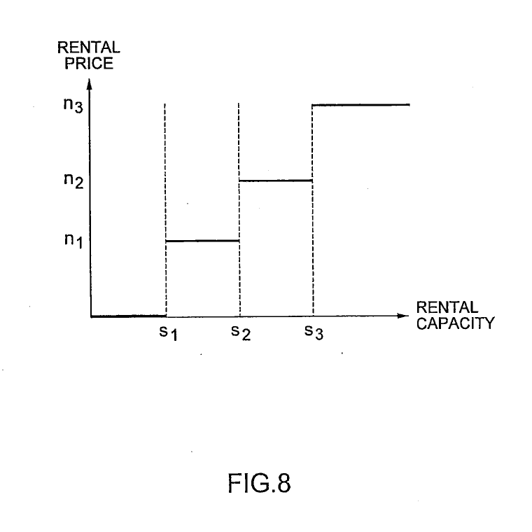

FIG. 8 is a graph showing one example of a price function obtained when the storage battery 16 is rented. An example in which the rental price is 0 yen when the rental capacity is 0 or more and less than s₁, n₁ yen when the rental capacity is s₁ or more and less than s₂, n₂ yen when the rental capacity is s₂ or more and less than s₃, and n₃ yen when the rental capacity is s₃ or more is shown. In the example shown in FIG. 8, the rental price is not affected by the length of the rental period. However, the price may also vary depending on the length of the rental period.

First, as a first step, a benefit obtained when the storage battery is rented is set as the objective function (S401). Any function may be employed as the price function as long as the function can be expressed by using an integer variable. In the following, the function shown in FIG. 8 will be described as an example.

First, a function

−(n₁z₁+n₂z₂+n₃z₃)

obtained by multiplying a rental benefit function by −1 is added as the objective function.

Moreover,

z₀+z₁+z₂+z₃=1

xᵣₑₙₜₐₗ_{_{—}}_{size}≧0

xᵣₑₙₜₐₗ_{_{—}}_{size}≧s₁z₁

xᵣₑₙₜₐₗ_{_{—}}_{size}≧s₂z₂

xᵣₑₙₜₐₗ_{_{—}}_{size}≧s₃z₃

z₀ε{0,1},z₁ε{0,1},z₂ε{0,1},z₃ε{0,1}

are registered as constraint expressions. When the objective function and the constraint expressions are set as described above, only one variable becomes 1 as “zₗ”. The function having a shape as shown in FIG. 8 can be thereby expressed. Even in a case of a function other than that in FIG. 8, any function can be formulated as long as the function can be expressed by using an integer variable.

As a second step, a following loop calculation is started by setting the internal variable “t” representing the time to 1.

As a third step,

$${Σ}_{t ∈ \{ 1 , … , T \}} {Σ}_{i ∈ N} {Σ}_{j ∈ N , j \neq 3} {c}_{ijt} {x}_{ijt}$$

as a power purchase cost function at the time “t” is added to the objective function (S402). The function represents a total cost for purchasing electric power from the power purchase node at the time “t”. Although electric power may be normally purchased from the power purchase node to the storage battery node and the household electrical appliance node (in a case of i=1 and j=4,5), the present embodiment is not limited thereto.

As a fourth step, a function

$${Σ}_{t ∈ \{ 1 , … , T \}} {Σ}_{i ∈ N} {c}_{i 3 t} {r}_{i 3 t} {x}_{i 3 t}$$

obtained by multiplying a power sale benefit function at the time “t” by −1 is added to the objective function (S403). The function represents a total benefit by selling electric power to the power sale node at the time “t”. A numerical value registered in the household electrical appliance setting information DB 20 is used as conversion efficiency for selling electric power to the system 41 from the storage battery. Although electric power may be normally sold to the power sale node from the power generation node and the storage battery node (in a case of i=2,4), the present embodiment is not limited thereto.

From the above description,

$${Σ}_{t ∈ \{ 1 , … , T \}} {Σ}_{i ∈ N} {Σ}_{j ∈ N , j \neq 3} {c}_{ijt} {x}_{ijt} - ( {n}_{1} {z}_{1} + {n}_{2} {z}_{2} + {n}_{3} {z}_{3} ) - {Σ}_{t ∈ \{ 1 , … , T \}} {Σ}_{i ∈ N} {c}_{i 3 t} {r}_{i 3 t} {x}_{i 3 t}$$

is obtained as an objective function (a first objective function) of the cost. The optimization computing unit 55 obtains a value of each variable such that the function is minimized while satisfying the constraint expressions produced in the steps in FIGS. 5 and 6, and the constraint expressions produced in the first step in FIG. 7.

When an objective function (a second objective function) of the benefit is produced as the objective function,

$$( {n}_{1} {z}_{1} + {n}_{2} {z}_{2} + {n}_{3} {z}_{3} ) - {Σ}_{t ∈ \{ 1 , … , T \}} {Σ}_{i ∈ N} {c}_{i 3 t} {r}_{i 3 t} {x}_{i 3 t} - {Σ}_{t ∈ \{ 1 , … , T \}} {Σ}_{i ∈ N} {Σ}_{j ∈ N , j \neq 3} {c}_{ijt} {x}_{ijt}$$

is produced. In this case, the optimization computing unit 55 obtains a value of each variable such that the function is maximized while satisfying the constraint expressions produced in the steps in FIGS. 5 and 6, and the constraint expressions produced in the first step in FIG. 7.

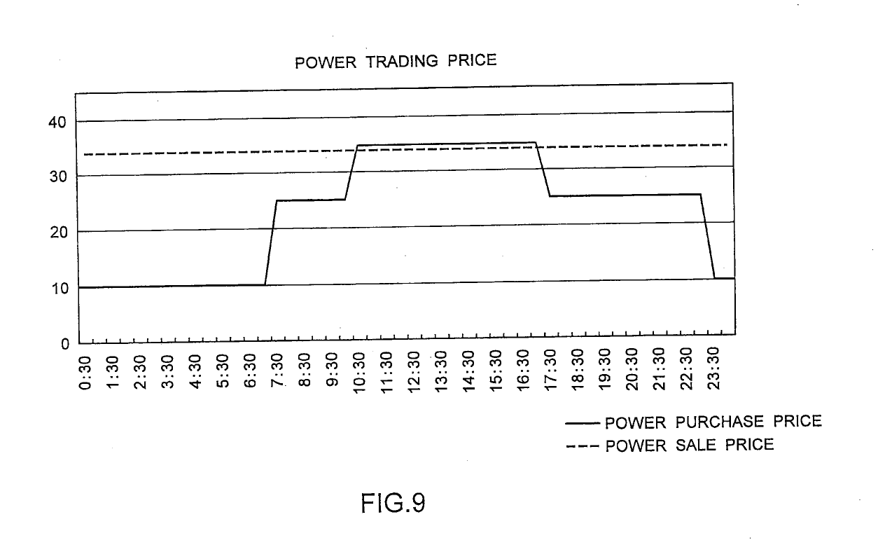

FIGS. 9 to 16 are graphs showing examples of results which can be obtained according to the input data and the procedure in FIGS. 3 to 7. Calculations were performed for 24 fours from 00:00 by setting the rental period to 11:00 to 14:00 and the rental price to 30 yen/kWh.

FIG. 9 is a graph showing one example of the power trading price as the input data. In the example, there are three power purchase prices differing in the morning and the evening, the daytime, and the nighttime, and one power sale price.

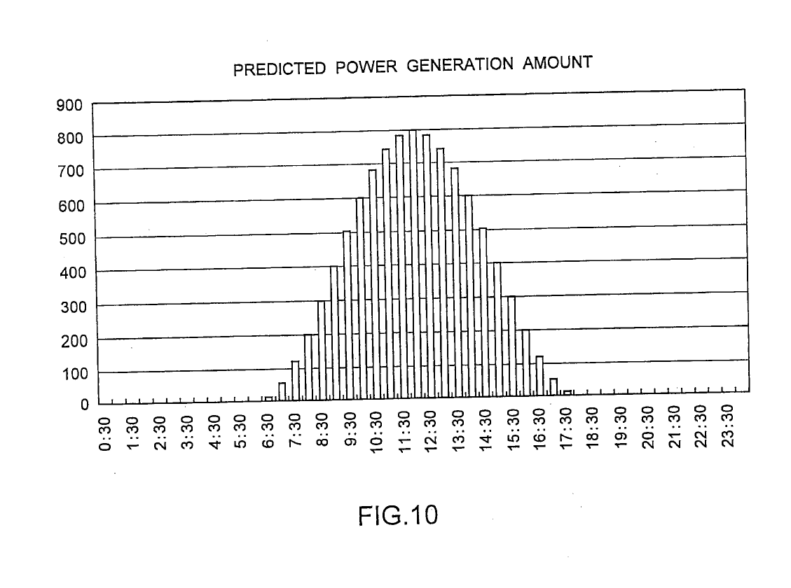

FIG. 10 is a graph showing one example of the predicted power generation amount created by the power generator predicting unit 52. In the example, there is a power generation peak in the daytime.

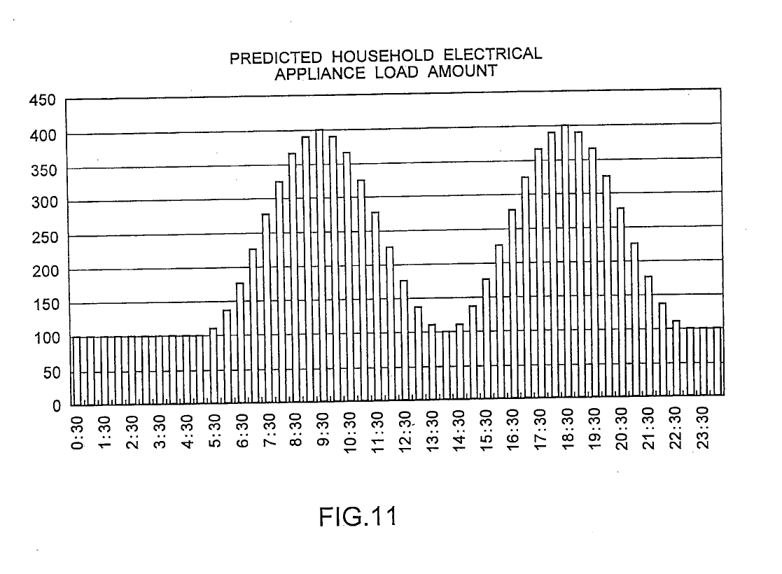

FIG. 11 is a graph showing one example of the predicted household electrical appliance load amount created by the appliance load predicting unit 51. In the example, there are two demand peaks in the mid-morning and the early evening, and in contrast, a demand at around noon is small.

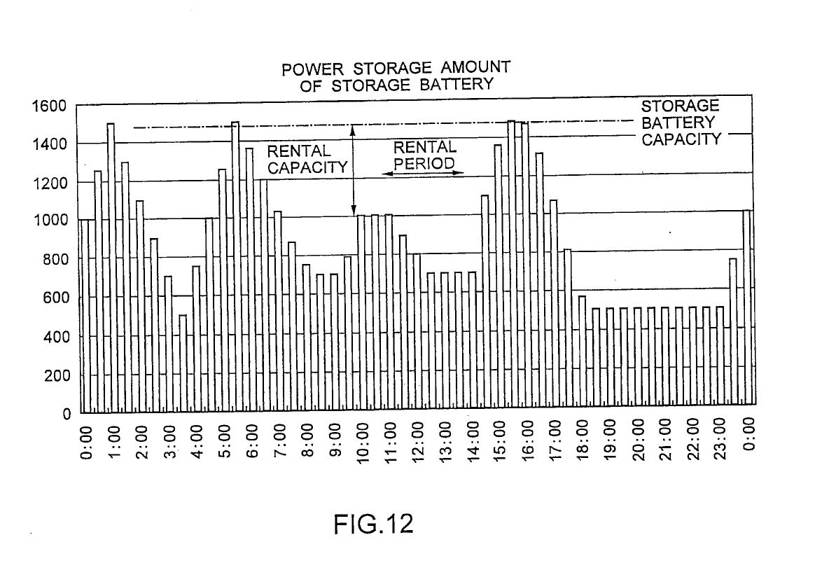

FIG. 12 is a graph showing a result example of the power storage amount of the storage battery 16 as one example of the obtained results.

First, a result that the rental capacity is about 500 Wh is obtained. That is, when the desired rental capacity is smaller than 500 Wh, the consumer replies that the rental capacity is rentable. When the desired rental capacity is larger than 500 Wh, the consumer replies that the rental capacity is not rentable. Since the consumer can also charge and discharge the storage battery during the rental period, the power storage amount is reduced during the rental period.

Since the power sale price is relatively high and the demand of the household electrical appliance 23 increases after the early-evening, a relatively large power storage amount is ensured in the storage battery before the rental period. More electric power is charged after the rental period so as to prepare for the demand after the early evening.

When a case in which the rental price is set to be higher or the demand after the early evening is reduced is taken into consideration, the rental capacity may be a little larger.

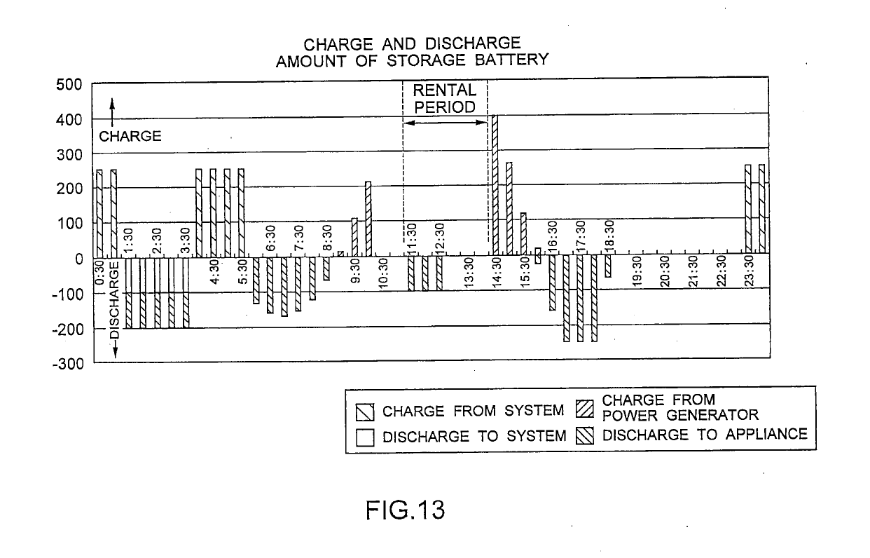

FIG. 13 is a graph showing a result example of the charge and discharge amount of the storage battery 16 as one example of the obtained results.

Since electric power is discharged from the storage battery even during the rental period, the power storage amount is reduced during the rental period. From FIG. 10, the power generator 19 generates a large amount of electric power in the daytime including the rental period. Thus, much electric power is charged into the storage battery 16 from the power generator 19. In the morning and the early evening in which the power generator 19 generates a small amount of electric power and the household load increases, much electric power is discharged to the household electrical appliance 23 from the storage battery 16. In the nighttime in which the power purchase price is low, much electric power is charged into the storage battery 16 from the system 41. When the storage battery 16 is fully charged, electric power is sold to the system 41.

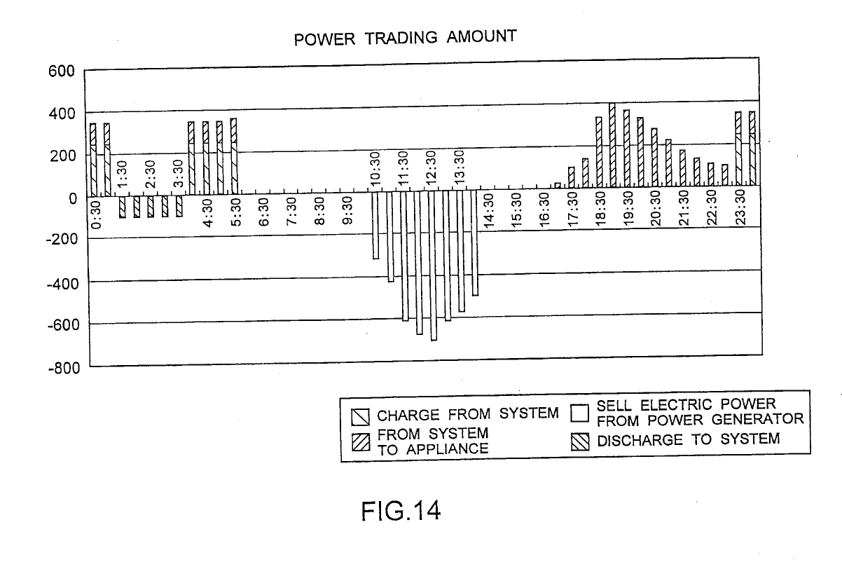

FIG. 14 is a graph showing a result example of the power trading amount with the system 41 as one example of the obtained results.

In the nighttime in which the power purchase price is low, a large amount of electric power is purchased. Particularly, a large amount of electric power is charged into the storage battery. On the contrary, in the daytime in which the power purchase price is highest, no electric power is purchased, but surplus electric power from the power generator 19 is sold. In the early evening in which the power purchase price is relatively low and the household load increases, the power purchase amount increases.

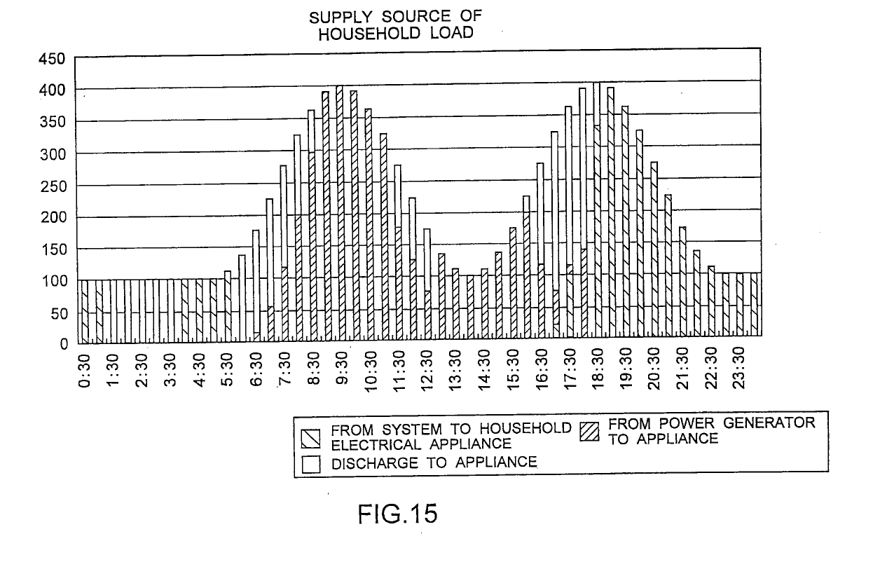

FIG. 15 is a graph showing a result example of a supply source of the household electrical appliance load as one example of the obtained results.

In the daytime in which the power purchase price is highest, electric power is supplied from the power generator 19 since the power generator 19 generates a large amount of electric power. In the morning and the early evening, electric power is mainly supplied from the storage battery 16. In the nighttime in which the storage battery 16 is empty, electric power is purchased from the system 41. Accordingly, the demand of the household electrical appliance 23 is satisfied.

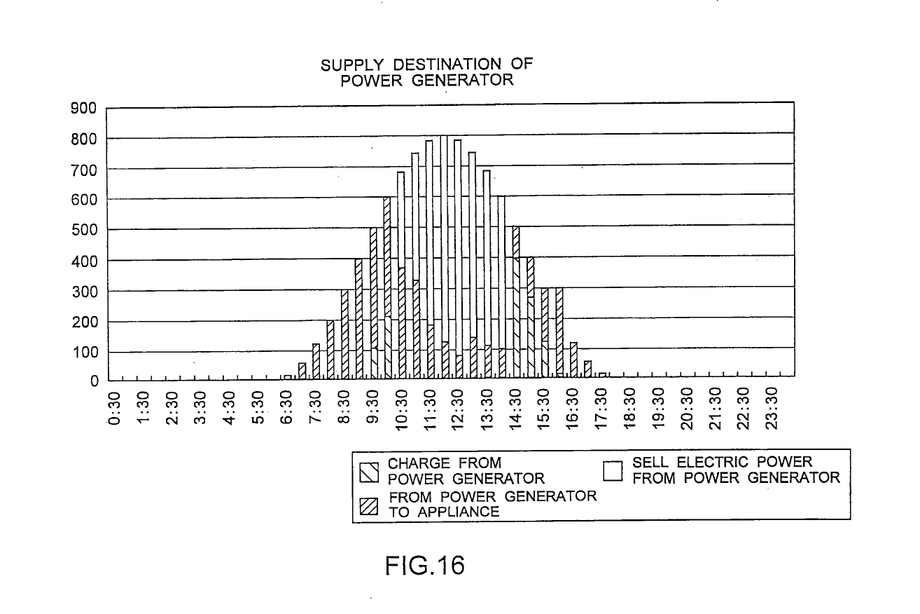

FIG. 16 is a graph showing a result example of a supply destination of the power generator 19 as one example of the obtained results.

When power generation is started in the morning, electric power is first supplied to the household electrical appliance 23. Electric power is then charged into the storage battery 16 at the same time. When the storage battery 16 is ready for rental, surplus electric power is sold to the system 41 while electric power is being supplied to the household electrical appliance 23. When the rental period is terminated, electric power is charged into the storage battery 16 again so as to satisfy the demand of the household electrical appliance 23 in the early evening.

As described above, in the embodiment of the present invention, the objective function (the first or second objective function) is produced based on the power purchase cost, the power sale benefit, and the rental benefit, and the objective function is optimized (minimized or maximized) so as to satisfy the constraint conditions partially including the rental conditions proposed by the power supplier. Accordingly, the consumer can obtain an appropriate storage battery rental capacity. The storage battery can be thereby reasonably determined to be rentable or not in response to the rental request specifying the desired rental capacity from the power supplier.

Next, a second embodiment according to the present invention will be described.

In the first embodiment, the case in which a plurality of users can charge and discharge the storage battery owned by the consumer at the same time is considered. That is, even during the rental period, not only the power supplier who receives the rental capacity, but also the consumer can use the storage battery. For example, in the graph in FIG. 13 showing the result example of the charge and discharge amount of the storage battery, a result that electric power is discharged to the household electrical appliance 23 of the consumer from the storage battery 16 from 11:00 to 12:30 during the rental period is shown.

However, there is a constraint that the storage battery owned by the consumer cannot be charged and discharged at the same time in many cases. Thus, a plurality of users cannot freely charge and discharge the storage battery as in the first embodiment. In the second embodiment, the case in which the storage battery owned by the consumer cannot be charged and discharged at the same time is assumed.

A configuration diagram of a storage battery sharing system, and a block diagram showing a configuration example of the storage battery rental capacity determining unit 13 according to the second embodiment are shown in FIGS. 1 and 2 as in the first embodiment. An operation flowchart of the storage battery rental capacity determining unit 13, and an operation flowchart of the objective function creating unit 54 according to the second embodiment are shown in FIGS. 3 and 7 as in the first embodiment.

Next, symbols changed or added in the second embodiment will be described.

“tᵣₑₙₜₐₗ_{_{—}}ₛₜₐᵣₜ” is the rental start time of the rental period proposed by the power supplier.

“I^{charge}” is changed to a constant that represents a lower limit power amount charged into the storage battery (I^{charge}≧0).

“u_{charge}” is changed to a constant that represents an upper limit power amount charged into the storage battery (u^{charge}≧0).

“I^{discharge}” is a constant that represents a lower limit power amount discharged from the storage battery (I^{discharge}≧0).

“u^{discharge}” is a constant that represents an upper limit power amount discharged from the storage battery (u^{discharge}≧0).

“zₜ^{charge}” is a variable that becomes 1 when electric power is charged into the storage battery at the time “t” (zₜ^{charge}≧0).

“zₜ^{discharge}” is a variable that becomes 1 when electric power is discharged from the storage battery at the time “t” (zₜ^{discharge}ε{0,1}).

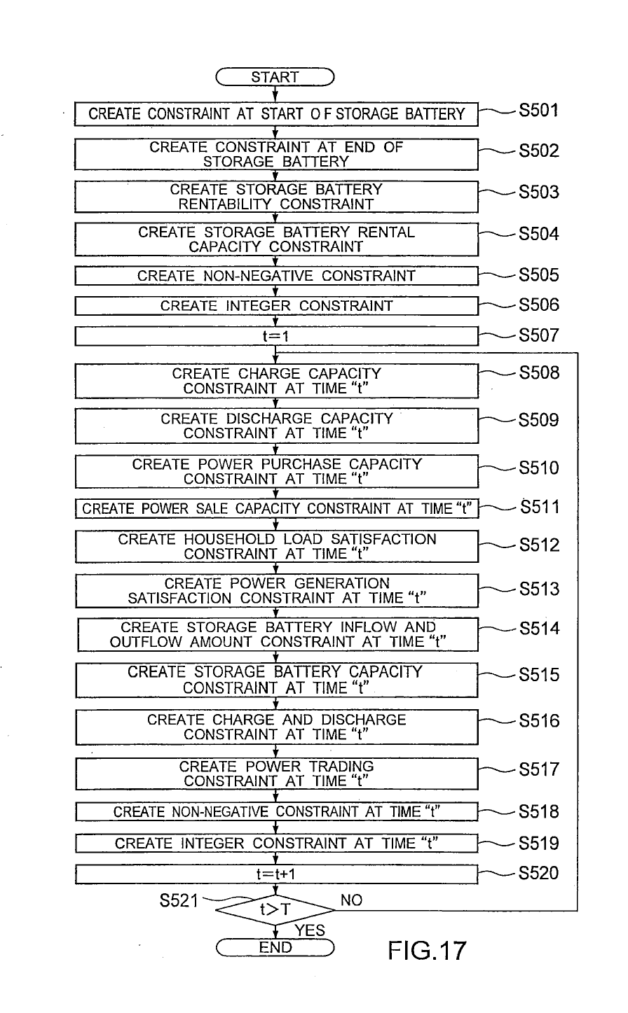

FIG. 17 is a flowchart showing one operation example of the constraint condition creating unit 53 according to the second embodiment.

First, in a first step,

x₄₄₀=b₀

as a constraint at the start of the storage battery is added as a constraint expression (S501). The constraint expression is a constraint expression for setting the initial capacity of the storage battery 16. A numerical value registered in the storage battery history DB 15 is used as “bₒ”.

In a second step,

x_{44T}=b_{T+1}

as a constraint at the end of the storage battery is added as a constraint expression (S502). The constraint expression is a constraint expression for setting the capacity of the storage battery at the end. A numerical value registered in the storage battery setting information DB 14 is used as “b_{T}”.

As a third step,

z_{yes}^{rental}+zₙₒ^{rental}=1

as a storage battery rentability constraint is added as a constraint expression (S503). The constraint expression is added so as not to determine, at the same time, to rent the rental capacity and not to rent the rental capacity.

As a fourth step,

0≦xᵣₑₙₜₐₗ_{_{—}}_{size}≦(u_{battery}−l^{battery})z_{yes}^{rental}

as a storage battery rental capacity constraint is added as a constraint expression (S504). The constraint expression is added so as to set an upper limit of the rental capacity to a maximum capacity of the storage battery when it is determined to rent the rental capacity, and so as to set the rental capacity to 0 when it is determined not to rent the rental capacity. Numerical values registered in the storage battery setting information DB are used as the upper and lower limits of the storage battery capacity.

As a fifth step,

xᵣₑₙₜₐₗ_{_{—}}_{size}≧0

as a non-negative constraint is added as a constraint expression (S505).

As a sixth step,

z_{yes}^{rental}ε{0,1},zₙₒ^{rental}ε{0,1}

as an integer constraint is added as a constraint expression (S506).

As a seventh step, a following loop calculation is started by setting an internal variable “t” representing the time to 1 (S507).

As an eighth step,

l^{charge}≦x₁₄ₜ+x₂₄ₜ≦u^{charge}zₜ^{charge∀}tε{1, 2, 3, . . . , T−1, T}

as a charge capacity constraint is added as a constraint expression (S508). The constraint expression is added so as to set upper and lower limit rates of charge into the storage battery 16 at the time “t”. Numerical values registered in the storage battery setting information DB 14 are used as the upper and lower limits of the storage battery charge rate. When it is determined not to charge the storage battery 16 at the time “t”, the right-hand side is set to 0.

As a ninth step,

l^{discharge}≦x₄₃ₜx₄₅ₜ≦u^{discharge}zₜ^{discharge∀}tε{1, 2, 3, . . . , T−1, T}

as a discharge capacity constraint is added as a constraint expression (S509). The constraint expression is added so as to set upper and lower limit rates of discharge from the storage battery at the time “t”. Numerical values registered in the storage battery setting information DB 14 are used as the upper and lower limits of the storage battery discharge rate. When it is determined not to discharge the storage battery at the time “t”, the right-hand side is set to 0.

As a tenth step,

l^{buy}≦x₁₄ₜ+x₁₅ₜ≦u^{buy}zₜ^{buy∀}tε{1, 2, 3, . . . , T−1, T}

as a power purchase capacity constraint is added as a constraint expression (S510). The constraint expression is added so as to set upper and lower limit rates for purchasing electric power from the system 41 at the time “t”. Numerical values registered in the household electrical appliance setting information DB 20 are used as the upper and lower limit rates for purchasing electric power. When it is determined not to purchase electric power from the system 41 at the time “t”, the right-hand side is set to 0.

As an eleventh step,

l^{sell}≦r₂₃x₂₃ₜr₄₃x₄₃ₜ≦u^{sell}zₜ^{sell∀}tε{1, 2, 3, . . . , T−1, T}

as a power sale capacity constraint is added as a constraint expression (S511). The constraint expression is added so as to set upper and lower limit rates for selling electric power to the system 41 at the time “t”. Numerical values registered in the household electrical appliance setting information DB 20 are used as the upper and lower limit rates for selling electric power. When it is determined not to sell electric power to the system 41 at the time “t”, the right-hand side is set to 0.

As a twelfth step,

x₁₅ₜ+r₂₅x₂₅ₜ+r₄₅x₄₅ₜ=dₜ^{∀}tε{1, 2, 3, . . . , T−1, T}

as a household load satisfaction constraint is added as a constraint expression (S512). The constraint expression is added so as to match the power demand amount of the household electrical appliance 23 with a sum of a purchase amount from the system 41, a supply amount from the power generator 19, and a discharge amount from the storage battery at the time “t”. Numerical values registered in the household electrical appliance setting information DB 20 are used as conversion efficiency for transmitting electric power from the power generator 19 to the household electrical appliance, and conversion efficiency for transmitting electric power from the storage battery 16 to the household electrical appliance.

As a thirteenth step,

x₂₃ₜ+x₂₄ₜ+x₂₅ₜ=pₜ^{∀}tε{1, 2, 3, . . . , T−1, T}

as a power generation satisfaction constraint is added as a constraint expression (S513). The constraint expression is added so as to match the power generation amount of the power generator 19 with a sum of a sale amount to the system 41, a charge amount into the storage battery 16, and a supply amount to the household electrical appliance 23 at the time “t”.

As a fourteenth step,

x₄₄ₜ₋₁+r₁₄x₁₄ₜ+x₂₄ₜ=x₄₃ₜ+x₄₄ₜ+x₄₅ₜ^{∀}tε{1, 2, 3, . . . , T−1, T}

as a storage battery inflow and outflow amount constraint is added as a constraint expression (S514). The constraint expression is added so as to match a sum of a carryover amount from a previous time, a purchase amount from the system 41, and a charge amount from the power generator 19 with a sum of a sale amount to the system 41, a carryover amount to a next time, and a supply amount to the household electrical appliance 23 at the time “t”. A numerical value registered in the household electrical appliance setting information DB 20 is used as conversion efficiency for transmitting electric power from the system 41 to the storage battery 16.

As a fifteenth step, a storage battery capacity constraint is added as a constraint expression. The step will be described in detail later (S515).

As a sixteenth step,

zₜ^{charge}+zₜ^{discharge}=1^{∀}tε{1, 2, 3, . . . , T−1, T}

as a charge and discharge constraint is added as a constraint expression (S516). The constraint expression is added so as not to determine, at the same time, to charge electric power into the storage battery 16 and to discharge electric power from the storage battery 16 at the time “t”. That is, the constraint expression is added so as to perform only one of charging into the storage battery 16 and discharging from the storage battery 16 at a time.

As a seventeenth step,

zₜ^{buy}+zₜ^{sell}=1^{∀}tε{1, 2, 3, . . . , T−1, T}

as a power trading constraint is added as a constraint expression (S517). The constraint expression is added so as not to determine to purchase electric power from the system 41 and to sell electric power to the system 41 at the same time at the time “t”.

As an eighteenth step,

xᵢⱼₜ≧0^{∀}tε{1, 2, 3, . . . , T−1, T},^{∀}iεN,^{∀}jεN

as a non-negative constraint is added as a constraint expression (S518).

As a nineteenth step,

zₜ^{buy}ε{0,1},zₜ^{sell}ε{0,1},zₜ^{charge}ε{0,1}^{∀}tε{1, 2, 3, . . . , T−1, T}

as an integer constraint is added as a constraint expression (S519).

As a twentieth step, 1 is added to the internal variable “t” representing the time (S520).

As a twenty-first step, the internal variable “t” is compared with an end time “T” (S521). The process is terminated when the internal variable “t” is larger. The process returns to the eighth step when the internal variable “t” is smaller.

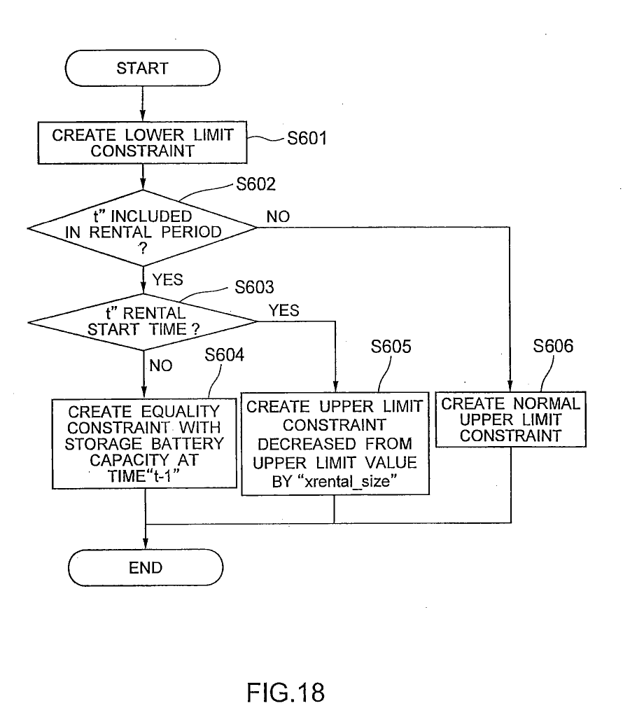

FIG. 18 is a flowchart showing one example of the storage battery capacity constraint (S515) in FIG. 17.

As a first step,

l^{battery}≦x₄₄ₜ₋₁^{∀}tε{1, 2, 3, . . . , T−1, T}

as a lower limit constraint of the storage battery capacity is added as a constraint expression (S601). The constraint expression is added so as to set a lower limit of the storage battery capacity at the time “t”. A numerical value registered in the storage battery setting information DB 14 is used as the lower limit of the storage battery capacity.

As a second step, it is confirmed whether the internal variable “t” is included in the rental period proposed by the power supplier (S602). When the internal variable “t” is not included, the process proceeds to a third step. When the internal variable “t” is included, the process proceeds to a fourth step.

As the third step,

x₄₄ₜ₋₁≦u^{battery∀}tεTₙₒₜ_{_{—}}ᵣₑₙₜₐₗ

as an upper limit constraint of the storage battery capacity is added as a constraint expression (S606). The constraint expression is added so as to set an upper limit of the storage battery capacity when the time “t” is out of the rental period. A numerical value registered in the storage battery setting information DB 14 is used as the upper limit of the storage battery capacity.

As the fourth step, it is confirmed whether the internal variable “t” and the rental start time proposed by the power supplier correspond to each other (S603). The process proceeds to a fifth step when the internal variable “t” and the rental start time correspond. The process proceeds to a sixth step when the internal variable “t” and the rental start time do not correspond.

As the fifth step,

$${x}_{44 {t}_{rental\_start} - 1} \leq {u}^{battery} - {x}_{rental\_size} if t = {t}_{rental\_start}$$

as an upper limit constraint of the storage battery capacity is added as a constraint expression (S605). The constraint expression is added so as to set the upper limit of the storage battery capacity to not the normal upper limit, but a value decreased by “Xᵣₑₙₜₐₗ_{_{—}}_{size}” since the time “t” is the start time of the rental period. A numerical value registered in the storage battery setting information DB 14 is used as the upper limit of the storage battery capacity.

As the sixth step,

x₄₄ₜ₋₁=x₄₄ₜ^{∀}tεTᵣₑₙₜₐₗ,t≠tᵣₑₙₜₐₗ_{_{—}}ₛₜₐᵣₜ

as an upper limit constraint of the storage battery capacity is added as a constraint expression (S604). The constraint expression is added so as to set the storage battery capacity to a capacity equal to the storage battery capacity at the previous time since the time “t” is in the rental period.

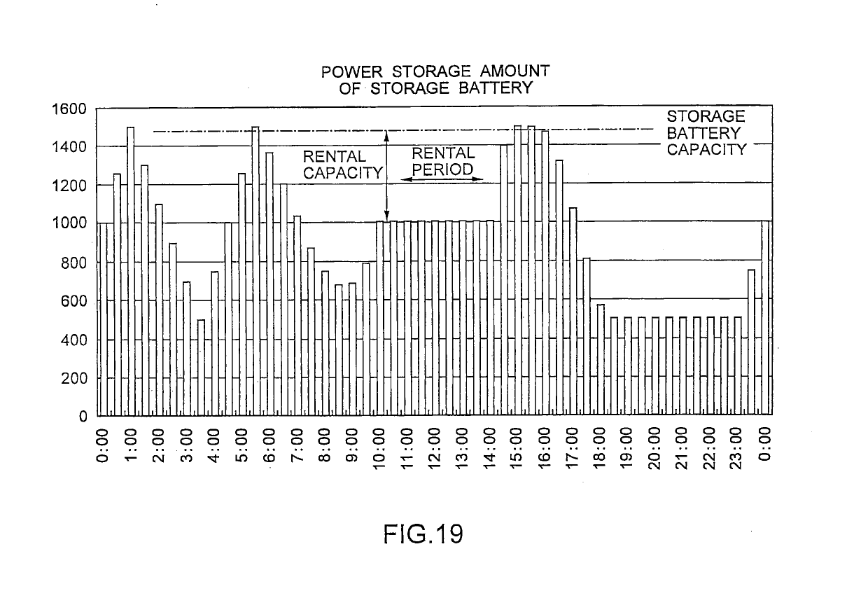

FIGS. 19 to 23 are graphs showing examples of results which can be obtained according to the second embodiment. The same conditions as those of the first embodiment are employed. The power trading price is as shown in FIG. 9, the predicted power generation amount is as shown in FIG. 10, and the predicted household electrical appliance load amount is as shown in FIG. 11. Calculations were performed for 24 fours from 00:00 by setting the rental period to 11:00 to 14:00 and the rental price to 30 yen/kWh.

FIG. 19 is a graph showing a result example of the power storage amount of the storage battery as one example of the results obtained in the second embodiment.

A result that the rental capacity is about 500 Wh is obtained. That is, when the desired rental capacity is smaller than the result, the consumer replies that the rental capacity is rentable. When the desired rental capacity is larger than the result, the consumer replies that the rental capacity is not rentable. Since the consumer cannot charge and discharge the storage battery during the rental period, the power storage amount is not changed.

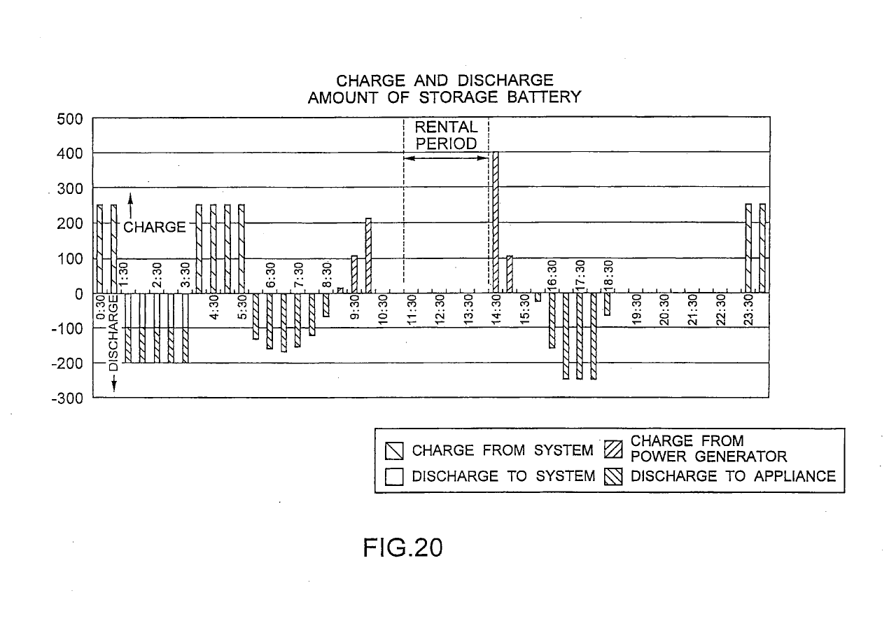

FIG. 20 is a graph showing a result example of the charge and discharge amount of the storage battery as one example of the results obtained in the second embodiment.

Since the consumer cannot charge and discharge the storage battery during the rental period, charging and discharging is not performed at all.

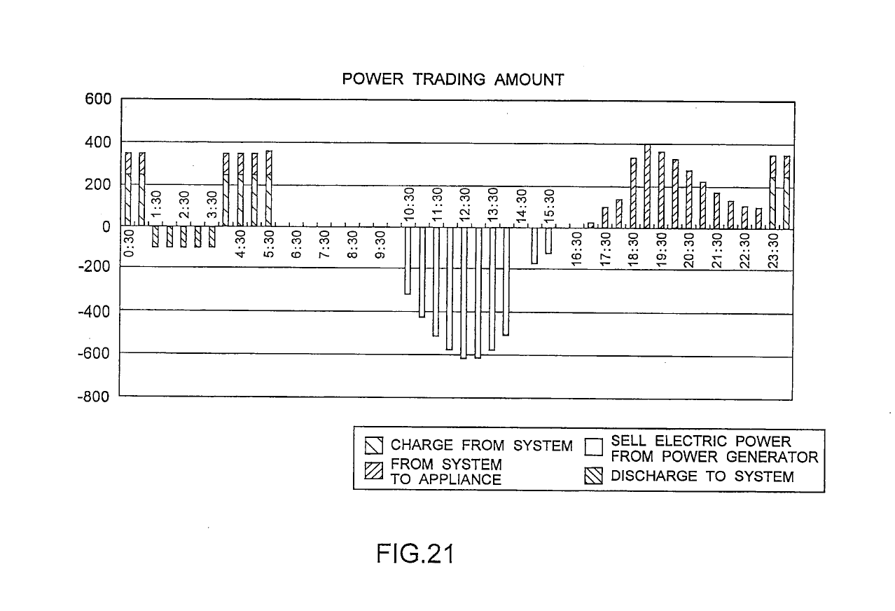

FIG. 21 is a graph showing a result example of the power trading amount with the system 41 as one example of the results obtained in the second embodiment.

The same result as that in FIG. 14 as the result of the first embodiment is obtained except that electric power is sold to the system 41 from the power generator 19 at around 16:00.

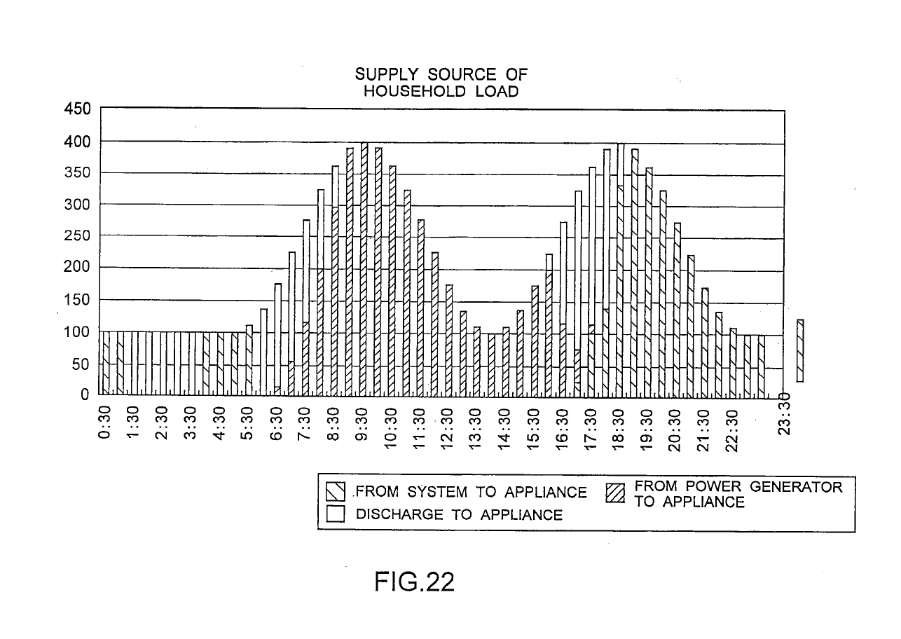

FIG. 22 is a graph showing a result example of a supply source of the household electrical appliance load as one example of the results obtained in the second embodiment.

The same result as that in FIG. 15 as the result of the first embodiment is obtained except that electric power is supplied only from the power generator 19 at around 11:00.

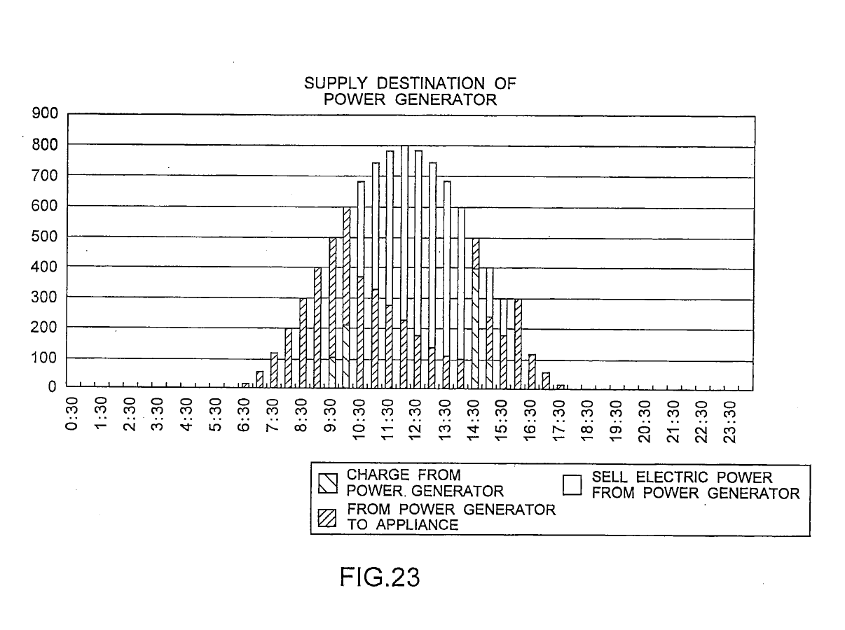

FIG. 23 is a graph showing a result example of a supply destination of the power generator 19 as one example of the results obtained in the second embodiment.

The same result as that in FIG. 16 as the result of the first embodiment is obtained except that the supply destination is changed at around 11:00 and around 16:00.

As described above, with the second embodiment, the consumer can obtain an appropriate storage battery rental capacity even when the storage battery owned by the consumer cannot be charged and discharged at the same time. The storage battery can be thereby reasonably determined to be rentable or not in response to the rental request specifying the desired rental capacity from the power supplier.

The systems and the storage battery rental capacity determining device in the first and second embodiments may also be realized using a general-purpose computer device as basic hardware. That is, the elements of the system and the device can be realized by causing a processor mounted in the above described computer device to execute a program. In this case, the apparatus may be realized by installing the above described program in the computer device beforehand or may be realized by storing the program in a storage medium such as a CD-ROM or distributing the above described program over a network and installing this program in the computer device as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A device that determines a rental capacity of a storage battery to rent to a power supplier a part or all of a capacity of the storage battery owned by a consumer who has a power generator, the storage battery, and a household electrical appliance, and purchases electric power from the power supplier, comprising:
a condition acquiring unit configured to acquire a rental condition of the storage battery, the rental condition including a rental period to the power supplier, and a rental price of each of rental capacities;
an appliance load predicting unit configured to predict a demand amount of the household electrical appliance with respect to a time zone including the rental period based on an operation history of the household electrical appliance;
a power generator predicting unit configured to predict a power generation amount of the power generator with respect to the time zone including the rental period based on an power generation history of the power generator;
a constraint condition creating unit configured to create a constraint condition including a first constraint expression and a second satisfaction constraint expression with respect to the time zone including the rental period wherein the first constraint expression is configured to match the demand amount of the household electrical appliance with total electric power supplied to the household electrical appliance from the power generator, the storage battery, and the power supplier, and the second constraint expression is configured to match the power generation amount of the power generator with a sum of a power sale amount to the power supplier, a charge amount into the storage battery, and a supply amount to the household electrical appliance;
an objective function creating unit configured to create a first objective function or a second objective function by using sale price data and purchase price data of electric power, a purchase cost function in the rental period, a sale benefit function in the rental period, and a rental benefit function of the rental capacity wherein the first objective function defines to subtract the sale benefit function and the rental benefit function from the purchase cost function, and the second objective function defines to subtract the purchase cost function from a sum of the sale benefit function and the rental benefit function; and
an optimization computing unit configured to minimize the first objective function or maximize the second objective function under the constraint condition to obtain a rental capacity rentable to the power supplier in the rental period.

2. The device according to claim 1,
wherein the constraint condition further includes a constraint expression that the capacity of the storage battery is equal to or less than a predetermined upper limit value except in the rental period, and is equal to or less than the rental capacity subtracted from the predetermined upper limit value during the rental period.

3. The device according to claim 2,
wherein the constraint condition further includes a constraint expression that only one of charging into the storage battery and discharging from the storage battery is performed at a time.

4. The device according to claim 1,
wherein the constraint condition creating unit and the objective function creating unit produce the constraint condition, and one of the first objective function and the second objective function in accordance with a mixed integer programming problem.

5. The device according to claim 1,
wherein the rental benefit function is a linear sum of variables representative of the rental capacities and rental prices of the rental capacities,
the constraint condition includes a constraint that the variables respectively have a value of 1 or 0, and a constraint that a sum of the variables is 1, and
the optimization computing unit determines a rental capacity corresponding to the variable having the value of 1 out of the variables as the rentable capacity.

6. The device according to claim 5,
wherein the purchase cost function defines to multiply variables representing amount of electric power supplied to the storage battery and the household electrical appliance from the power supplier by costs to transmit electric power to the storage battery and the household electrical appliance from the power supplier, and add resultant values.

7. The device according to claim 5,
wherein the sale benefit function defines to multiply variables representing amount of electric power supplied to the power supplier from the storage battery and the power generator by costs to transmit electric power to the power supplier from the storage battery and the power generator, and add resultant values.

8. The device according to claim 1,
wherein the storage battery rental condition includes a desired rental capacity by the power supplier, and
the device further comprises a rentability determining unit configured to transmit a response that the rental capacity is rentable to the power supplier when the rental capacity determined by the optimization computing unit is equal to or more than the desired rental capacity, and transmits a response that the rental capacity is not rentable to the power supplier when the determined rental capacity is less than the desired rental capacity.

9. A method that determines a rental condition of a storage battery to rent to a power supplier a part or all of a capacity of the storage battery owned by a consumer who has a power generator, the storage battery, and a household electrical appliance, and purchases electric power from the power supplier, comprising:
acquiring a rental condition of the storage battery, the rental condition including a rental period to the power supplier, and a rental price of each of rental capacities;
predicting a demand amount of the household electrical appliance with respect to a time zone including the rental period based on an operation history of the household electrical appliance;
predicting a power generation amount of the power generator with respect to the time zone including the rental period based on an power generation history of the power generator;
creating a constraint condition including a first constraint expression and a second satisfaction constraint expression with respect to the time zone including the rental period wherein the first constraint expression is configured to match the demand amount of the household electrical appliance with total electric power supplied to the household electrical appliance from the power generator, the storage battery, and the power supplier, and the second constraint expression is configured to match the power generation amount of the power generator with a sum of a power sale amount to the power supplier, a charge amount into the storage battery, and a supply amount to the household electrical appliance;
creating a first objective function or a second objective function by using sale price data and purchase price data of electric power, a purchase cost function in the rental period, a sale benefit function in the rental period, and a rental benefit function of the rental capacity wherein the first objective function defines to subtract the sale benefit function and the rental benefit function from the purchase cost function, and the second objective function defines to subtract the purchase cost function from a sum of the sale benefit function and the rental benefit function; and
minimizing the first objective function or maximizing the second objective function under the constraint condition to obtain a rental capacity rentable to the power supplier in the rental period.
